(19) United States
(12) Patent Application Publication
(10) Pub. No.: US 2008/0090555 A1
(43) Pub. Date: Apr. 17, 2008

(54) Managing Faults and Filters in Providing Foreign Services

(76) Inventors: Pulin R. Patel, McKinney, TX (US); Rashad Mohammad Ali, Plano, TX (US); Zeev V. Lubenski, Richardson, TX (US); Mahbubul Alam, Mckinney, TX (US)

Correspondence Address: FISH & RICHARDSON P.C., P.O. BOX 1022, MINNEAPOLIS, MN, 55440-1022, US

(21) Appl. No.: 11/550,309

(22) Filed: Oct. 17, 2006

(51) Int. Cl. H04Q 7/38

(52) U.S. Cl. 455/414.1

(57) ABSTRACT

The disclosure provides a system and method for managing fault in providing foreign services. In some embodiments, a method includes providing services foreign to each of a plurality of communication devices. The services are provided by core networks. Services native to each of the plurality of communication devices is substantially maintained in response to at least identifying a fault in providing foreign services.

### TECHNICAL FIELD

This invention relates to telecommunications and, more particularly, to managing faults and filters in providing foreign services.

### BACKGROUND

Communication networks include wired and wireless networks. Example wired networks include the Public Switched Telephone Network (PSTN) and the Internet. Example wireless networks include cellular networks as well as unlicensed wireless networks that connect to wire networks. Calls and other communications may be connected across wired and wireless networks.

Cellular networks are radio networks made up of a number of radio cells, or cells, that are each served by a base station or other fixed transceiver. The cells are used to cover different areas in order to provide radio coverage over a wide area. When a cell phone moves from place to place, it is handed off from cell to cell to maintain a connection. The handoff mechanism differs depending on the type of cellular network. Example cellular networks include Universal Mobile Telecommunications System (UMTS), Wide-band Code Division Multiple Access (WCDMA), and CDMA2000. Cellular networks communicate in a radio frequency band licensed and controlled by the government.

### SUMMARY

The disclosure provides a system and method for managing fault in providing foreign services. In some embodiments, a method includes providing services foreign to each of a plurality of communication devices. The services are provided by core networks. Services native to each of the plurality of communication devices is substantially maintained in response to at least identifying a fault in providing foreign services.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a fault management system in accordance with some embodiments of the present disclosure;

FIG. 2 is a communication node of FIG. 1 in accordance with some embodiments of the present disclosure; and

FIG. 3 is a flow diagram illustrating an example method for managing faults in providing foreign services.

Like reference symbols in the various drawings indicate like elements.

### DETAILED DESCRIPTION

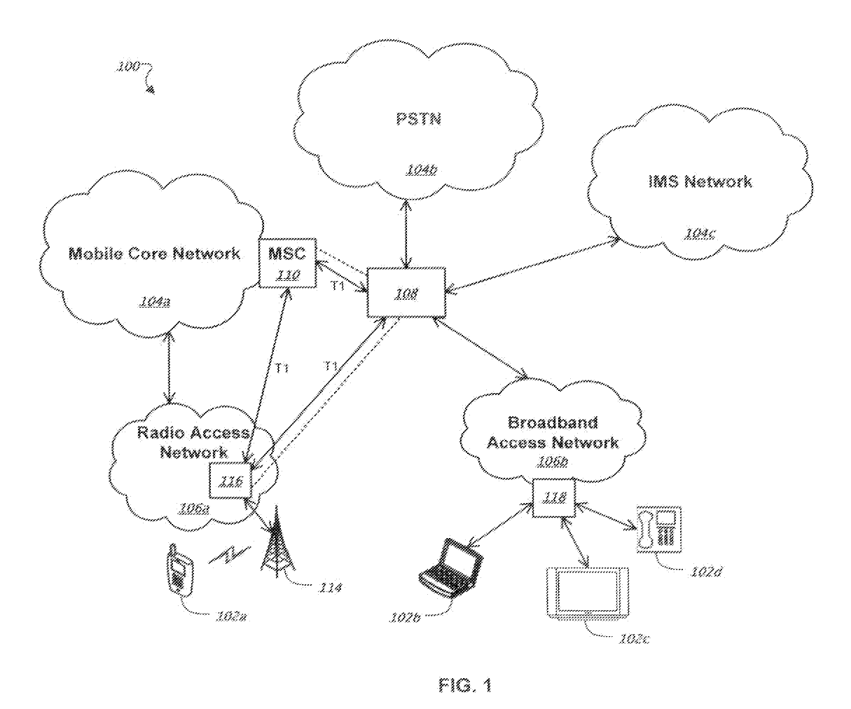

FIG. 1 illustrates a communication system 100 for managing faults in providing foreign services. In general, a foreign service, as used herein, means any service provided by a core network 104 that can not directly accessed or otherwise communicated to a device 102. Indeed, this foreign service is merely in terms of particular core networks 104—in order words, the foreign service may be directly provided to other devices 102. In other words, a communication device 102 may be foreign to a core network 104 and, thus, unable to communicate directly with or receive services from that core network 104. In identifying messages accessing these foreign services, system 100 may filter or otherwise identify messages accessing native services and messages accessing foreign services. In the event of a fault, system 100 may be unable to access or otherwise provide foreign services to a device 102. To overcome interruptions to native services, system 100 may automatically direct messages accessing native service independent of interruptions to foreign services. For example, system 100 may automatically route, switch, or otherwise direct messages to core networks 104 native to communication devices 102. As a result, system 100 may eliminate, minimize or reduce interruption to native services. For instance, system 100 may provide IMS services to a specific GSM device 102. In the event that these foreign IMS services are interrupted, system 100 may automatically direct messages from the specific GSM device or other GSM devices 102 directly to the native GSM core network 104.

At a high level, system 100 includes devices 102, core networks 104, access networks 106, and communication node 108. Each communication device 102 comprises an electronic device operable to receive and transmit network communication with system 100. As used in this disclosure, communication devices 102 are intended to encompass cellular phones, data phones, pagers, portable and stationary computers, smart phones, personal data assistants (PDAs), televisions, electronic gaming devices, one or more processors within these or other devices, or any other suitable processing devices capable of communicating information over a wireless or wired link to access networks 106. Generally, the communication devices 102 may transmit voice, video, multimedia, text, web content or any other user/client-specific content. In short, device 102 generates requests, responses or otherwise communicates with core networks 104 via access networks 106. For purposes of example, a cellular device 102a communicates with radio access network (RAN) 106a and a SIP telephone device 102b, a computer 102c, and a display 102d are shown communicating with broadband access network 106b.

In the illustrate embodiment, core networks 104 include mobile core network 104a, Public Switched Telephone Network (PSTN) 104b, and IP Multimedia Subsystem (IMS) network 104c. Mobile core network 104a typically includes various switching elements and gateways for providing cellular services. Mobile core network 104a often provides these services via a number of Radio Access Networks (RANs), such as RAN 106a, and also interfaces the cellular system with other communication systems such as PSTN 104b via mobile switching center (MSC) 110. In accordance with the Global System for Mobile Communications (GMS) standard, mobile core network 104a includes a circuit switched (or voice switching) portion for processing voice calls and a packet switched (or data switching) portion for supporting data transfers such as, for example, e-mail messages and web browsing. The circuit switched portion includes MSC 110 that switches or connects telephone calls between RAN 106a and PSTN 104b or another network. The packet-switched portion, also known as General Packet Radio Service (GPRS), includes a Serving GPRS Support Node (SGSN) (not illustrated), similar to MSC 110, for serving and tracking communication devices 102, and a Gateway GPRS Support Node (GGSN) (not illustrated) for establishing connections between packet-switched networks and communication devices 102. The SGSN may also contain subscriber data useful for establishing and handing over call connections. Mobile core network 104a may also include a home location register (HLR) for maintaining “permanent” subscriber data and a visitor location register (VLR) (and/or an SGSN) for “temporarily” maintaining subscriber data retrieved from the HLR and up-to-date information on the location of those communications devices 102 using a wireless communications method. In addition, mobile core network 104a may include Authentication, Authorization, and Accounting (AAA) that performs the role of authenticating, authorizing, and accounting for devices 102 operable to access mobile core network 104a.

PSTN 104b comprises a circuit-switched network that provides fixed telephone services. A circuit-switched network provides a dedicated, fixed amount of capacity (a “circuit”) between the two devices for the duration of a transmission session. In general, PSTN 104b may transmit voice, other audio, video, and data signals. In transmitting signals, PSTN 104b may use one or more of the following: telephones, key telephone systems, private branch exchange trunks, and certain data arrangements. Since PSTN 104b may be a collection of different telephone networks, portions of PSTN 104b may use different transmission media and/or compression techniques. Completion of a circuit in PSTN 104b between a call originator and a call receiver may require network signaling in the forms of either dial pulses or multi-frequency tones.

IMS network 104c is a network that enables mobile communication technology to access IP based services. The IMS standard was introduced by the 3^{rd} generation partnership project (3GPP) which is the European 3^{rd} generation mobile communication standard. In general, the IMS standard discloses a method of receiving an IP based service through a wireless communication terminal such as mobile devices 102. To achieve these goals, IMS network 104c uses SIP and, in some embodiments, mobile device 102 is operable to use the same protocol when accessing services through broadband network 106b. Although not illustrated, IMS network 104c may include call session control function (CSCF), home subscriber server (HSS), application server (AS), and other elements. CSCF acts as a proxy and routes SIP messages to IMS network components such as AS. HSS typically functions as a data repository for subscriber profile information, such as type of services allowed for a subscriber. AS provides various services for users of IMS network 104c, such as, for example, video conferencing, in which case AS handles the audio and video synchronization and distribution to mobile devices 102.

Turning to access networks 106, access networks 106 include RAN 106a and broadband network 106b. RAN 106a provides a radio interface between mobile devices 102 and cellular core network 104a that may provide real-time voice, data, and multimedia services (e.g., a call) to mobile devices 102. In general, RAN 106a communicates air frames 112 via radio frequency (RF) links. In particular, RAN 106a converts between air frames 112 to physical link based messages for transmission through cellular core network 104a. RAN 106a may implement, for example, one of the following wireless interface standards during transmission: IS-65 (TDMA), Advanced Mobile Phone Service (AMPS), GSM standards, CDMA, Time Division Multiple Access (TMDA), General Packet Radio Service (GPRS), ENHANCED DATA rates for Global EVOLUTION (EDGE), or proprietary radio interfaces.

RAN 106a may include Base Stations (BS) 114 connected to Base Station Controllers (BSC) 116. BS 114 receives and transmits air frames 112 within a geographic region of RAN 106a called a cell and communicates with mobile devices 102 in the cell. Each BSC 116 is associated with one or more BS 114 and controls the associated BS 114. For example, BSC 116 may provide functions such as handover, cell configuration data, control of RF power levels or any other suitable functions for managing radio resource and routing signals to and from BS 114. MSC 110 handles access to BSC 116 and communication node 108, which may appear as a BSC 116 to MSC 110. MSC 110 may be connected to BSC 116 through a standard interface such as the A-interface.

Broadband network 106b facilitates communication between mobile devices 102 and communication node 108. In general, network 106b communicates IP packets to transfer voice, video, data, and other suitable information between network addresses. In the case of multimedia sessions, network 106b uses Voice over IP (VoIP) protocols to set up, route, and tear down calls. Network 106b may include one or more local area networks (LANs), metropolitan area networks (MANs), wide area networks (WANs), all or a portion of the global computer network known as the Internet, and/or any other communication system or systems at one or more locations. In the illustrated embodiment, IP network 106b includes SIP proxy servers 134 for routing SIP messages. Each SIP proxy server can be any software, hardware, and/or firmware operable to route SIP messages to other SIP proxies, gateways, SIP phones, communication node 108, and others.

In general, communication node 108 can include any software, hardware, and/or firmware operable to provide access to foreign services. For example, node 108 may provide mobile device 102 services from IMS core network 102c. In providing foreign services, node 108 may perform one or more of the following: identify device 102 requesting services including type of device, identify core network 104 associated with requested services, determine whether the services are foreign, determine whether device 102 may access the requested services, and translate services to forms compatible with requesting devices 102. In identifying the requesting device 102, node 108 may use information included in messages transmitted from device 102. For example, node 108 may identify a Temporary Mobile Subscription Identifier (TMSI) included in a message transmitted by mobile device 102a. Using the TMSI, node 108 may identify an International Mobile Subscription Identifier (IMSI) associated with mobile device 102a. In some cases, node 108 locally stores a correspondence between TMSI and IMSI. In connection with identifying device 102a, node 108 may identify foreign services that the requesting device 102 may access. In some embodiments, node 108 identifies subscription information associated with the requesting device 102. Returning to the example, node 108 may determine that mobile device 102a may access video on demand services from IMS core network 104c. In some embodiments, node 108 may locally store subscription information associated with one or more mobile devices 102. In this case, the requesting device 102 may have access to the subscribed foreign services while being prevented from accessing other foreign services.

In addition, node 108 may manage faults in providing access to foreign services. For example, node 108 may directly switch, route or otherwise direct messages to native core networks 104 in the event that access to foreign services is interrupted. For example, node 108 may directly route messages from mobile device 102a directly to mobile core network 104a in the event of a fault. Similarly, node 108 may directly route messages from broadband network 104b directly to IMS network 104c in the event of a fault. In directly routing messages to native core networks 104, node 108 may be able to eliminate, minimize or reduce interruptions to native services.

Communication node 108 may convert between different communication technologies. For example, communication node 108 may receive a GSM request from mobile device 102 to access services from IMS network 104c. In this case, communication node 108 may convert the GMS request to a SIP request prior to transmitting the request to IMS network 104c. The conversion may include conversion between parameters of different communication technologies and/or bit conversion. In addition, communication node 108 may also be operable to convert other broadband messages such as SIP messages to cellular radio technology messages such as GSM messages. For example, communication node 108 may be receive a SIP request from mobile device 102 to access services from cellular core network 104a, and prior to transmitting the message to cellular core network 104a, communication node 108 may convert the SIP request to a GSM request.

Communication node 108 may, in one embodiment, emulate or otherwise represent itself as an element of core network 104. For example, communication node 108 may emulate or otherwise represent itself as a BSC, MSC, PCSCF (not illustrated) or other element of a core network 104. In the case that communication node 108 emulates a BSC, communication node 108 may be queried by MSC 110 in cellular core network 104a like any other BSC 116. In the case of communication node 108 emulating a MSC, communication node 108 may query BSC 116 and perform call management functions associated with MSCs (e.g., Mobility Management, Call Control, Services). In the case that communication node 108 emulates a PCSCF, communication node 108 may be queried by CSCF in IMS network 104c like any other PCSCF.

In one aspect of operation, a communication device 102 transmits a request to communication node 108 for a foreign service. In response to at least the request, communication node 108 identifies device 102 and determines whether the requesting device 102 may access the foreign service. In the event that device 102 may access the foreign service, node 108 may convert the request to a form compatible with the associated core network 104. In the event that a fault occurs with node 108, node 108 may be switch, reconfigured, or otherwise updated to direct traffic to native core networks 104. In this case, node 108 may reduce interruption to native services.

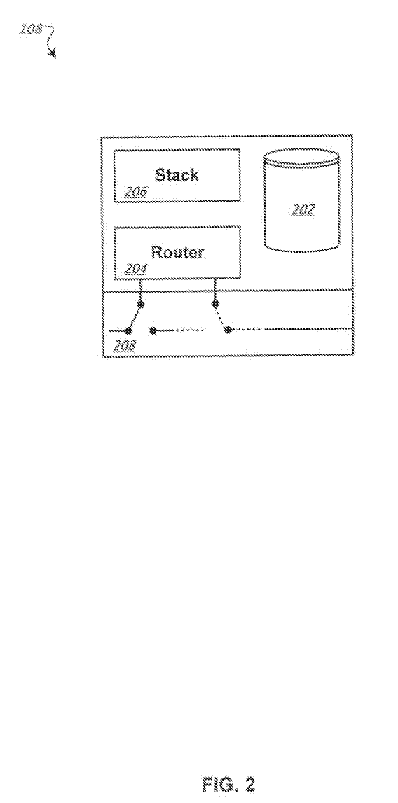

FIG. 2 illustrate communication node 108 of FIG. 1 for managing faults in providing foreign services. It will be understood that the illustrated communication node 108 is for illustration purposes only. Communication node 108 may include all, some, or different features and functions described below without departing from scope of this disclosure. Moreover, communication node 108 ay use any other suitable elements for performing the same functions.

In the illustrated embodiment, communication node 108 includes a local memory 202, a router 204, a stack 206, and a switching element 208. Local memory 202 may include any memory or database module and may take the form of volatile or non-volatile memory including, without limitation, magnetic media, optical media, random access memory (RAM), read-only memory (ROM), removable media, or any other suitable local or remote memory component. In the illustrated embodiment, memory 202 includes subscription information, but may include other information without departing from the scope of this disclosure. Subscription information may include any parameters, pointers, variables, algorithms, instructions, rules, files, links, or other data for providing foreign services to communication devices 102. In some embodiments, subscription information may include or otherwise identify one or more of the following: a device type, an identifier, subscribed services, or other information associated with accessing foreign services. For example, memory 202 may store a TMSI and a corresponding IMSI for identifying services that mobile device 102a may access. The subscription information may also identify core networks 104 that a device 102 may access as well as specific services provided by the identified core network 104 that may be provided to device 102.

The illustrated node 108 also includes router engine 204 and stack engine 206 for executing at least some instructions and manipulating at least some data to perform operations of node 108. Although FIG. 2 illustrates router engine 204 and stack engine 206 as single modules in node 108, multiple modules may be used according to particular needs, and reference to router engine 204 and/or stack engine 206 is means to include multiple modules where applicable. Router engine 204 includes any hardware, software, and/or firmware operable to identify messages associated with foreign services. For example, router engine 204 may determined that the message originated from a device 102 that may access foreign services. In this case, router engine 204 may identify a TMSI based, at least in part, on a message from mobile device 102a. Using the TMSI, router engine 204 may identify the corresponding IMSI in memory 202 as having a subscription to foreign services. In the event that a message is associated with a foreign service request, router engine 204 may pass the message to stack engine 206. In the event that the message is associated with a native service request, router engine 204 directs the message to the native core network 104.

Stack engine 206 can include any hardware, software, and/or firmware operable to determine whether the identified device 102 may access the requested foreign service. For example, stack engine 206 may retrieve or otherwise identify subscription information from memory 202. Based, at least in part, on the subscription information, stack engine 206 may determine whether device 102 may access the foreign core network 104 and/or whether device 102 may access the foreign service. For example, stack engine 206 may determine that GSM device 102a may access the request movie-on-demand service from IMS network 104c. In the event that device 102 may access the requested foreign service, node 108 may convert the message to a form compatible with the foreign core network 104.

Switching element 208 can include any hardware, software, and/or firmware operable to manage faults in requesting foreign services. For example, switching element 208 may directly pass traffic through node 108 in the event of a fault in providing foreign services. During normal operation, switching element 208 may direct ingress traffic to route engine 204 for identifying messages associated with foreign services. Switching element 208 and/or another element of node 108 may monitor network activity, operational aspects of node 108, or other activities to identify faults in providing foreign services. In the event of a fault, switching element 208 may selectively switch to pass ingress traffic to directly to native core networks 104.

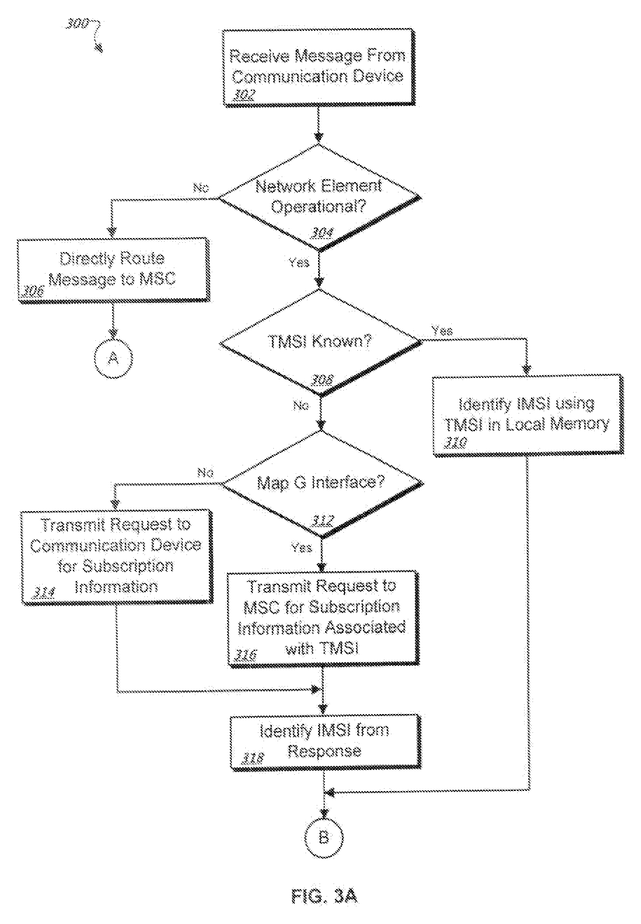

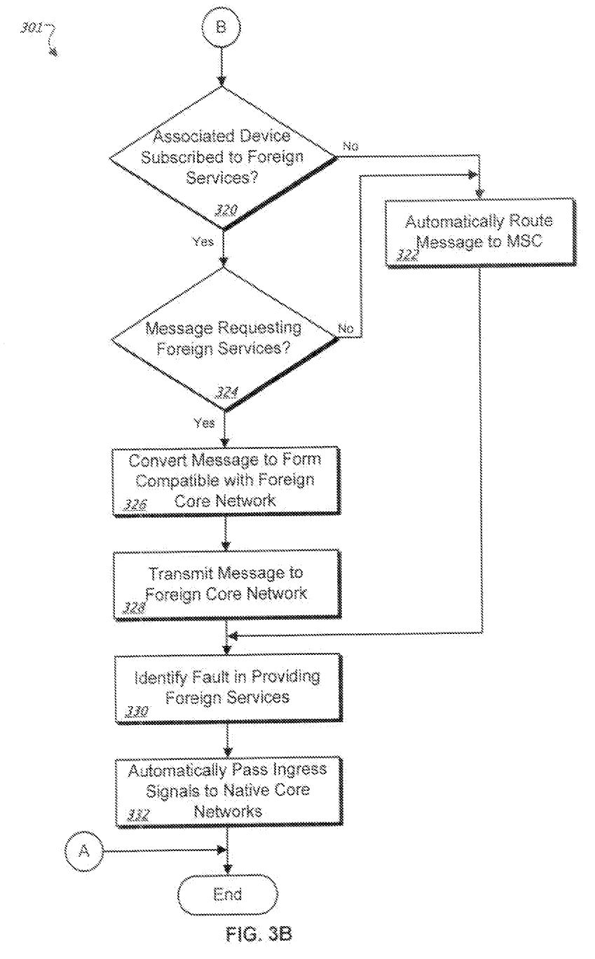

FIG. 3 is a flowchart illustrating an example methods 300 for managing faults in providing foreign services in accordance with some embodiments of the present disclosure. Generally, method 300 describes an example technique for communication node 108 to provide foreign services to communication devices 102 and substantially maintain native services in the event of an interruption in providing the foreign services. The following descriptions will primarily focus on the operation of communication node 108 in performing this method. But system 100 contemplates using any appropriate combination and arrangement of logical elements implementing some or all of the described functionality.

At a high level, method 300 includes two process: (1) providing foreign services to a communication device 102 in steps 302 to 328; and (2) directly routing signals to native core networks 104 in the event of a fault in steps 330 to 332. Method 300 begins at step 302 where communication node 108 receives a message from GSM device 102a. If the communication node 108 is not operating in regards to providing foreign services at decisional step 304, then, at step 306, communication node 108 directly routes the GSM message to MSC 110. If the communication node 108 is operating in regards to providing foreign services at decisional step 304, then execution proceeds to decisional step 308. If communication node 108 identifies the TMSI using the received message, then, at step 310, communication node 108 identifies an IMSI using the TMSI. If the communication is unable to identify the TMSI, then execution proceeds to decisional step 312. If communication node 108 does not include a Map-G interface for identifying the TMSI, then, at step 314, communication node 108 transmits a request to GSM device 102a for subscription information including the associated IMSI. If communication node 108 does include a Map-G interface for identifying the TMSI, then, at step 316, communication node 108 transmits a request for the subscription information to an MSC 110 in accordance with LAI included in the message. Next, communication node 108 identifies the associated IMSI from a response from MSC 110 at step 320. If communication node 108 determines, using the IMSI, that GSM device 102a does not have a subscription to foreign services at decisional step 320, then, at step 322, communication node 108 automatically routes the message to GSM core network 104a. If communication node 108 determines, using the IMSI, that GSM device 102a does have a subscription to foreign services at decisional step 320, then execution proceeds to decisional step 324. If the message is not requesting foreign services, then the message is routed to MSC 110 at step 322. If the message is requesting foreign services, communication node 108 converts the request to a form compatible with the associated foreign core network (e.g., IMS network 104c) at step 326. Communication node 108 transmits the converted message to the foreign core network 104 at step 328.

Turning to the fault management process, communication node 108, at step 330, identifies a fault in providing foreign services to GSM device 102a. In response to at least the fault, communication node 108, at step 332, directly routes ingress signals to core networks 104 native to each signal. For example, communication node 108 may selectively switch switching element 208 to automatically route ingress signals to native core networks 104.

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
providing services foreign to each of a plurality of communication devices, the services provided by core networks; and
substantially maintaining services native to each of the plurality of communication devices in response to at least identifying a fault in providing foreign services.

2. The method of claim 1, further comprising:
receiving additional service requests from a subset of the communication devices; and
wherein substantially maintaining services comprises directly routing the service requests to core networks native to the subset of the communication devices.

3. The method of claim 1, the plurality of communication devices comprising wireless communication devices.

4. The method of claim 1, the foreign services comprising broadband services.

5. A method, comprising:
receiving signals from a plurality of communication devices;
providing services foreign to at least one of the communication devices;
identifying a fault associated with providing the foreign services; and
automatically switching additional signals to core networks native to originating communication devices in response to at least the identified fault.

6. The method of claim 5, the at least one of the communication devices comprising a broadband device.

7. The method of claim 5, the foreign services comprising, mobile core network services.

8. The method of claim 5, the fault comprising an interruption in an ability to provide the foreign services.

9. The method of claim 5, wherein automatically switching additional signals comprises directly passing additional signals to core networks native to originating communication devices.

10. A method, comprising:
receiving, from a communication device, a request for services foreign to the communication device;
providing the foreign services to the communication device in accordance with subscription information;
detecting an interruption to foreign services associated with at least one core network; and
directly routing ingress signals from the communication device to a core network native to the communication device.

11. The method of claim 10, further comprising directly routing additional signals from a plurality of communication devices to core networks native to the plurality of communication devices.

12. The method of claim 10, the subscription information comprising an mobile identification number.

13. The method of claim 10, wherein providing the foreign services comprises:
identifying a mobile identification number based, at least in part, on the service request; and
identifying a subscription to the foreign services based, at least in part, on the mobile identification number.

14. A method, comprising:
receiving, from a plurality of communication devices, requests for services associated with core networks, at least a subset of the request comprising request for foreign services; and
in response to at least a fault in providing foreign services, directly routing the requests to core networks native to each of the plurality of communication devices independent of a type of request.

15. The method of claim 14, further comprising:
filtering the service requests for services associated with core networks foreign to requesting communication device; and
providing the foreign service to the requesting device in accordance with associated subscription information.

16. The method of claim 14, the communication devices comprising mobile devices.

17. The method of claim 14, the foreign services comprising broadband services.

18. The method of claim 14, the foreign services comprising different foreign services, the method further comprising providing the different core services to a single communication device.

19. A method, comprising:
receiving request for services from access networks, the services provided by core networks foreign to the access networks; and
directly routing requests for services to core networks native to originating access networks in response to detecting a fault in providing foreign services.

20. The method of claim 19, the access networks comprising at least a Radio Area Access (RAN) network and a broadband network.

21. The method of claim 19, the core networks comprising at least a GSM core network and an IMS network.

22. A communication node, comprising:
a service engine configured to provide services foreign to each of a plurality of communication devices, the services provided by core networks; and
a switching element configured to substantially maintain services native to each of the plurality of communication devices in response to at least identifying a fault in providing foreign services.

23. The node of claim 22, further comprising:
a request engine receiving additional service requests from a subset of the communication devices; and
wherein the switching element configured to substantially maintain services comprises the switching element configured to directly route the service requests to core networks native to the subset of the communication devices.

24. The node of claim 22, the plurality of communication devices comprising wireless communication devices.

25. The node of claim 22, the foreign services comprising broadband services.

26. A communication node, comprising:
a request engine operable to receive signals from a plurality of communication devices;
a service engine operable to provide services foreign to at least one of the communication devices;
a management engine configured to identify a fault associated with providing the foreign services; and
a switching element configured to automatically switch additional signals to core networks native to originating communication devices in response to at least the identified fault.

27. The node of claim 26, the at least one of the communication devices comprising a broadband device.

28. The node of claim 26, the foreign services comprising mobile core network services.

29. The node of claim 26, the fault comprising an interruption in an ability to provide the foreign services.

30. The node of claim 26, wherein the switching element configured to automatically switch additional signals comprises the switching element configured to directly pass additional signals to core networks native to originating communication devices.

31. A communication node, comprising:
a request engine configured to receive, from a communication device, a request for services foreign to the communication device;
a service engine configured to provide the foreign services to the communication device in accordance with subscription information;
a management engine configured to detect an interruption to foreign services associated with at least one core network; and
a switching element configured to directly route ingress signals from the communication device to a core network native to the communication device.

32. The node of claim 31, the switching element further configured to directly routing additional signals from a plurality of communication devices to core networks native to the plurality of communication devices.

33. The node of claim 31, the subscription information comprising an mobile identification number.

34. The node of claim 31, wherein the service engine configured to provide the foreign services comprises the service engine configured to:
identify a mobile identification number based, at least in part, on the service request; and
identify a subscription to the foreign services based, at least in part, on the mobile identification number.

35. A communication node, comprising:
a request engine configured to receive, from a plurality of communication devices, requests for services associated with core networks, at least a subset of the request comprising request for foreign services; and
a switching element configured to directly routing the requests to core networks native to each of the plurality of communication devices independent of a type of request in response to at least a fault in providing foreign services.

36. The node of claim 35, further comprising:
a filtering engine configured to filter the service requests for services associated with core networks foreign to requesting communication device; and
a service engine configured to provide the foreign service to the requesting device in accordance with associated subscription information.

37. The node of claim 35, the communication devices comprising mobile devices.

38. The node of claim 35, the foreign services comprising broadband services.

39. The node of claim 35, the foreign services comprising different foreign services, the node further comprising a service engine configured to provide the different core services to a single communication device.

40. A communication node, comprising:
a service engine configured to receive request for services from access networks, the services provided by core networks foreign to the access networks; and
a switching element configured to directly route requests for services to core networks native to originating access networks in response to detecting a fault in providing foreign services.

41. The node of claim 40, the access networks comprising at least a Radio Area Access (RAN) network and a broadband network.

42. The node of claim 40, the core networks comprising at least a GSM core network and an IMS network.
